(19) United States
(12) Patent Application Publication
(10) Pub. No.: US 2022/0155013 A1
(43) Pub. Date: May 19, 2022

(54) DEVICE AND METHOD FOR THERMAL OR THERMO-CHEMICAL TREATMENT OF MATERIAL

(71) Applicant: ONEJOON GMBH, Bovenden (DE)

(72) Inventor: Arian Esfehanian, Böblingen (DE)

(21) Appl. No.: 17/602,810

(22) PCT Filed: Apr. 7, 2020
(86) PCT No.: PCT/EP2020/059929

§ 371 Date: Oct. 11, 2021

(30) Foreign Application Priority Data
Apr. 12, 2019 (DE) 10 2019 109 767.3

(51) Int. Cl. F27B 9/14; F27B 9/04; F27B 9/32; F27D 3/06; F27D 1/18; H01M 4/04; H01M 4/485

(52) U.S. Cl. CPC F27B 9/142; F27B 9/045; F27B 9/32; F27B 2009/382; F27D 1/1858; H01M 4/0471; H01M 4/485; F27D 3/06

(57) ABSTRACT

A device for thermal or thermo-chemical treatment, in particular calcination, of material, in particular battery cathode material, having a housing and a process chamber in the housing, in which there is a process chamber atmosphere during the treatment and which defines a conveying level. The material, or carrying structures loaded with the material, at the conveying level can be conveyed in a conveying direction into and/or through the process chamber by a conveying system. An entry airlock gate defines an inlet level and includes an airlock gate chamber, an airlock gate inlet and an airlock gate outlet, as well as an inlet conveyor which is designed so that the material or carrying structures loaded with the material at the inlet level can be conveyed through the airlock gate inlet and into the airlock gate chamber. The conveying level and the inlet level are different from one another. A method for thermal or thermo-chemical treatment, in particular calcination, of material, in particular battery cathode material, in which the material or carrying structures loaded with the material at the conveying level and the inlet level are conveyed at different heights.

The invention relates to an apparatus for the thermal or thermochemical treatment, in particular calcination, of material, in particular of battery cathode material, comprising
a) a housing;
b) a process space which is located in the housing and in which a process space atmosphere prevails during the treatment and which defines a transport level;
c) a transport system by means of which the material or carrier structures loaded with the material can be transported on the transport level in a transport direction into and/or through the process space;
d) an entry lock which defines an inlet level and
   da) comprises a lock space, a lock inlet and a lock outlet;
   db) comprises an inlet conveyor which is configured in such a way that the material or carrier structures loaded with the material can be transported on the inlet level through the lock inlet into the lock space.

In addition, the invention relates to a process for the thermal or thermochemical treatment, in particular calcination, of material, in particular battery cathode material, wherein
a) the material or carrier structures loaded with the material are transported on a transport level through a process space of an apparatus for the thermal treatment of the material in which a process gas atmosphere prevails;
b) the material or carrier structures loaded with material are transported on an inlet level into a lock space of an entry lock.

In the production of lithium ion batteries, for example, calcination of a pulverulent cathode material is carried out in an oxygen-containing atmosphere in such apparatuses and using such processes. The pulverulent cathode material is, for example, a lithium-containing transition metal precursor which is calcined in the furnace to give a lithium-transition metal oxide. In this procedure, water or carbon dioxide CO₂ is liberated as offgas from the lithium-containing transition metal precursor, depending on whether lithium hydroxide or lithium carbonate precursors are used.

However, apparatuses and processes of the abovementioned type are in principle also used for the thermal treatment of other materials which can also be, for example, workpieces which have to be appropriately thermally or thermochemically treated in the presence of a process gas.

The temperatures in such furnaces can be up to 1200° C. In the following text, the invention will be explained for the example of the thermal treatment of cathode material as mentioned above. The temperature at which the calcination of such materials takes place in practice depends in a manner known per se on the material to be treated and the type of furnace used.

Owing to the process atmosphere in the process space, this material to be treated can only be fed in via an entry lock, which is frequently a double gate lock.

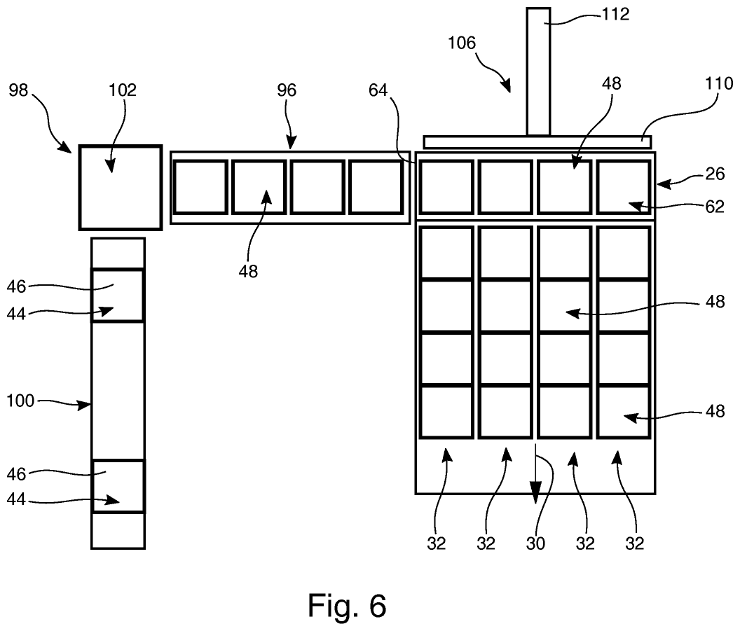

The transport system by means of which material or carrier structures loaded with material are transported through the process space frequently comprises components and constituents which are arranged upstream, relative to the transport direction, of the entry into the process space. For this reason, the inlet lock is generally supplied from the side, based on the transport direction. However, a comparatively large plant area is in this case required for the transport equipment by means of which the material or carrier structures loaded with material are positioned before entry into the entry lock. This is illustrated again further below with the aid of FIG. 6.

It is an object of the invention to provide an apparatus and a process of the type mentioned at the outset by means of which construction space can be saved in the installation of the apparatus.

This object is achieved in an apparatus of the type mentioned at the outset by
e) the transport level and the inlet level being different from one another.

The transport level and the inlet level are thus at different heights. It has been recognized that it is in this way possible to arrange the transport equipment both of the transport system for transport through the process space and also for transport into the lock space in such a way that, without mutual interference, the inlet lock can also be supplied in the transport direction.

It is particularly advantageous for the transport level to be lower than the inlet level.

The entry lock preferably comprises a lift device having a transport structure by means of which the material or carrier structures loaded with material can be moved from the inlet level to the transport level.

Here, the transport structure preferably comprises at least one carrier table or at least one grasping unit.

The inlet conveyor is advantageously configured so that the material or carrier structures loaded with material can be transported on the inlet level onto the transport structure of the lift device.

In a first variant, the lock inlet and the lock outlet can be arranged in such a way that the material or carrier structures loaded with material can pass through both of them in the same direction.

In this case, the material or carrier structures loaded with material can preferably pass in the transport direction through the lock inlet and the lock outlet.

In a second variant, the lock inlet and the lock outlet can be arranged in such a way that the material or carrier structures loaded with material can pass through them in different directions.

In this case, it is advantageous for
a) at least either the lock inlet or the lock outlet to be arranged in such a way that the material or carrier structures loaded with material can pass through it in the transport direction;

and/or
b) at least either the lock inlet or the lock outlet to be arranged in such a way that the material or carrier structures loaded with material can pass through it in the vertical direction.

The concept described above can advantageously be implemented when the transport system comprises a drive device having drive components which are arranged outside the apparatus upstream, relative to the transport direction, of the entry into the process space.

The entry lock is preferably configured so that a change of atmosphere can be carried out in the lock space.

In the case of the process of the type mentioned at the outset, the object indicated above is achieved by
c) the material or carrier structures loaded with material being transported on the transport level and the inlet level at different heights.

A change of atmosphere is preferably carried out in the lock space when material or carrier structures loaded with material are introduced into the process space.

The material or carrier structures loaded with material are advantageously moved in the lock space from the inlet level to the transport level while carrying out the change of atmosphere.

Preference is given to using an apparatus having some or all of the abovementioned features for this purpose.

Working examples of the invention will be described in detail below with the aid of the drawings. The drawings show:

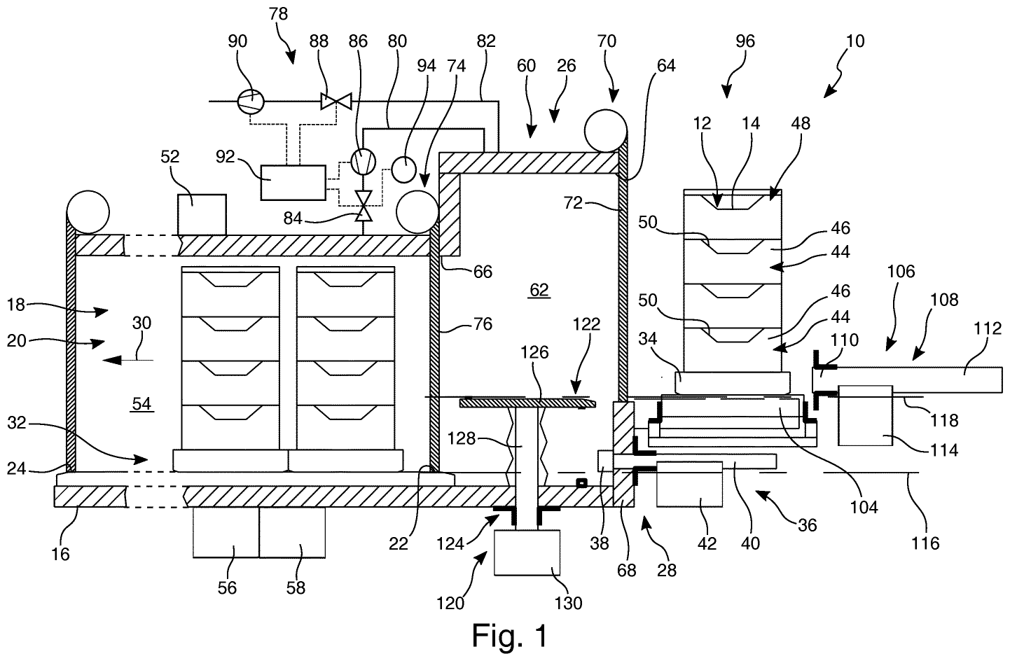

FIG. 1 a vertical longitudinal section of an entry region of a continuous furnace having an entry lock as per a first working example;

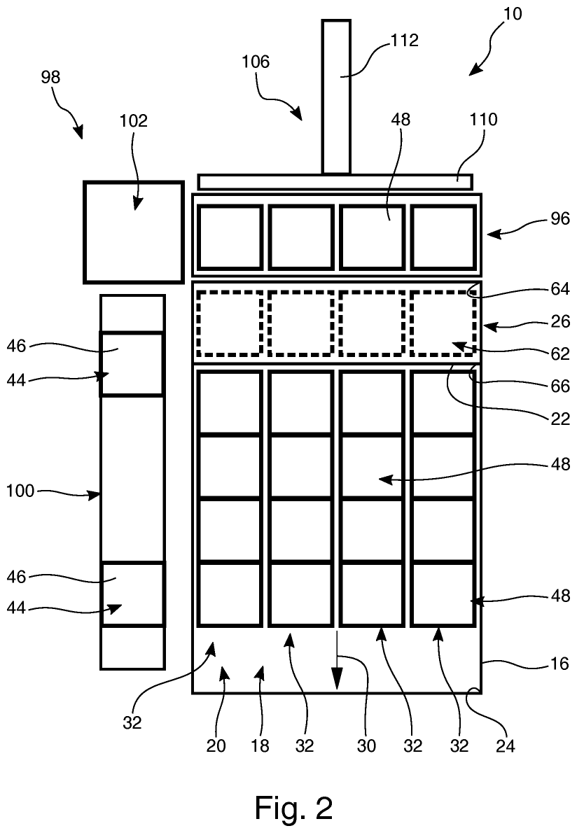

FIG. 2 a plan view of the continuous furnace of FIG. 1;

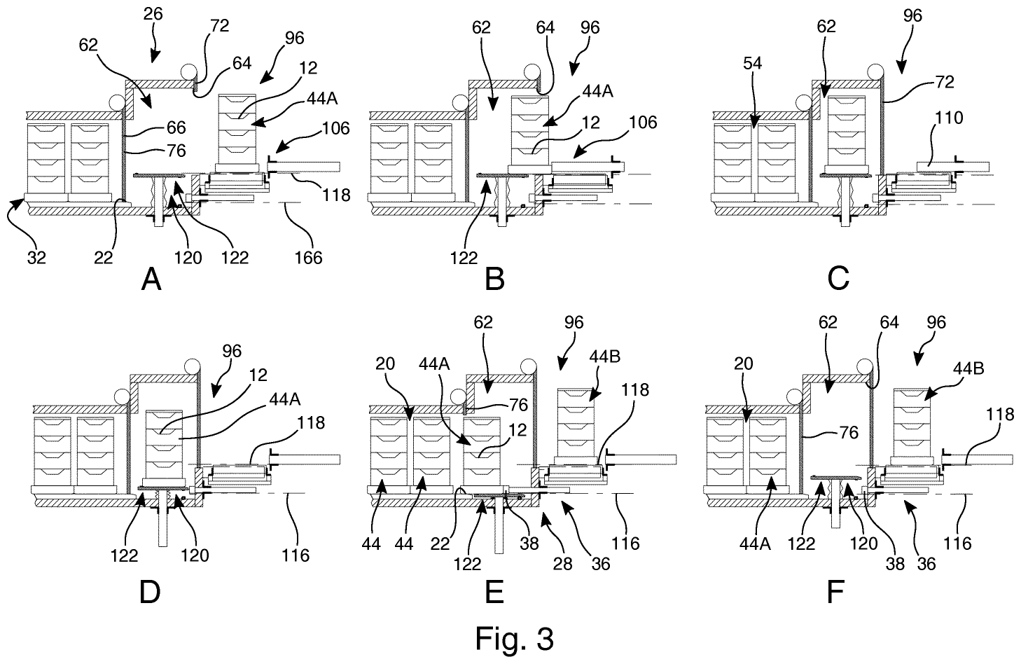

FIGS. 3A to 3F various phases during the introduction of material into the continuous furnace of FIG. 1;

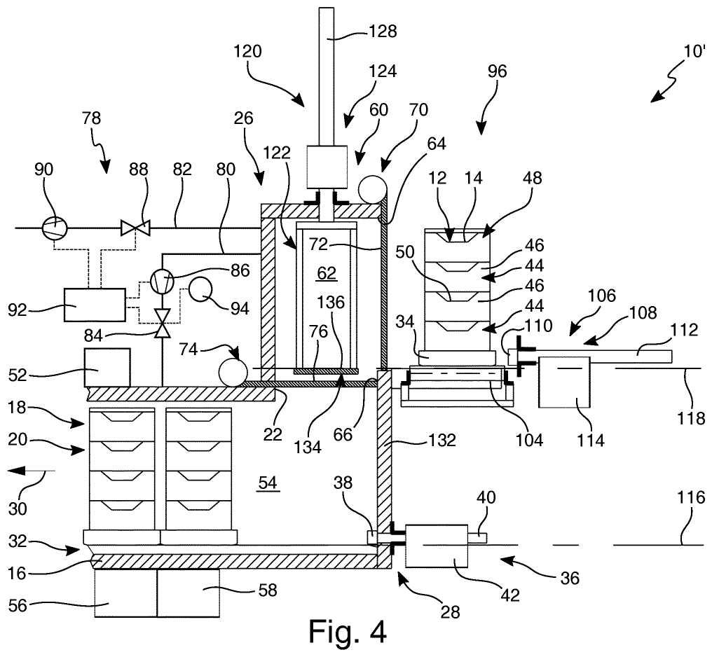

FIG. 4 a vertical longitudinal section of an entry region of a continuous furnace having an entry lock as per a second working example;

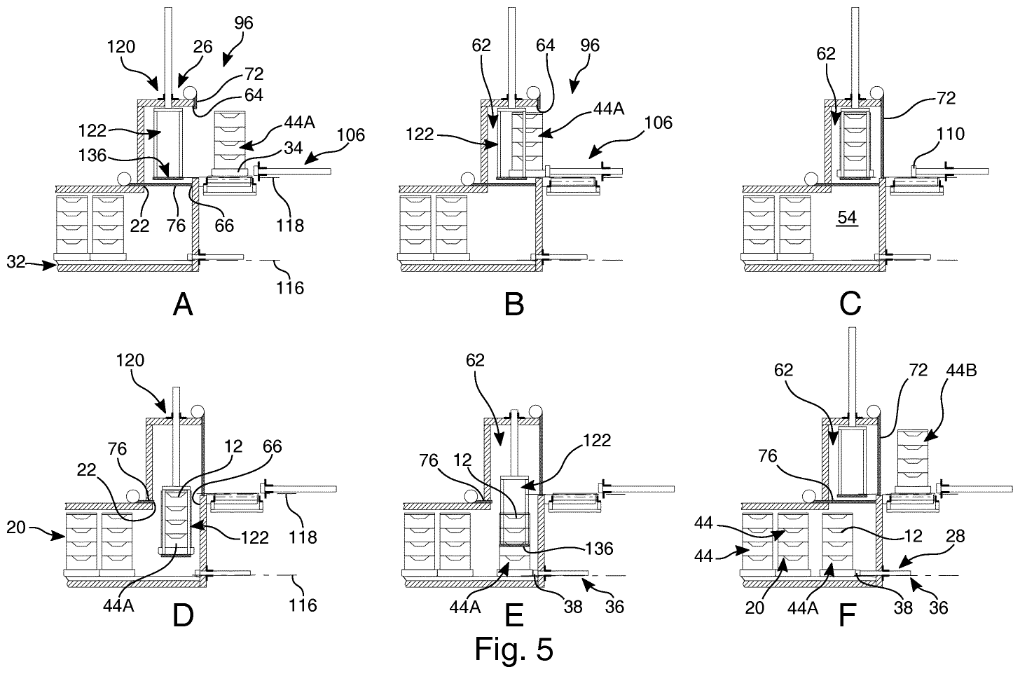

FIGS. 5A to 5F various phases during introduction of material into the continuous furnace of FIG. 4;

FIG. 6 a plan view corresponding to FIG. 2 of a continuous furnace according to the prior art;

FIG. 5 a plan view of the continuous furnace of FIG. 1 or 3;

FIG. 6 a plan view of a continuous furnace according to the prior art.

Firstly, reference will be made to FIGS. 1, 2 and 5. In these, 10 denotes an apparatus for the thermal treatment of material 12. In the following, this apparatus 10 will in the interests of simplicity be referred to as furnace 10.

The material 12 can be, for example, battery cathode material 14 as indicated at the outset which has to be calcined by a thermal treatment in the furnace 10 in the production of batteries.

The furnace 10 comprises a housing 16 which delimits an interior space 18 in which a process space 20 is located. The housing 16 in the present case delimits the process space 20. The interior space of the furnace 10 can optionally be defined by a separate housing surrounding the housing 16.

The process space 20 extends between an entry 22 and an exit 24 of the housing 16, with only the exit 24 being shown in FIG. 1. An entry lock 26 is present at the entry 22 of the process space 20. Separation of the atmosphere in the process space 20 from the surrounding atmosphere is ensured by the entry lock 26. At the exit 24, there is an exit lock which is, however, not shown individually and can be configured in a manner known per se. An exit lock can optionally also be in principle designed as explained for the entry lock 26 in the text below.

The material 12 is conveyed in a transport direction 30 through the process space 20 by means of a transport system 28; the transport direction 30 is indicated by an arrow only in FIGS. 1, 2, 4 and 6. The furnace 10 is designed as a continuous furnace and specifically as pusher furnace in which the transport system 28 conveys the material 12 through the furnace 10. For this purpose, the transport system 28 comprises a plurality of transporter tracks 32 along which a plurality of support trays 34 are pushed, as is known per se. In the figures, only one support tray 34 is provided with a reference numeral. As can be seen from FIG. 2, four parallel transport tracks 32 are present in the working example here. However, only one, two or three or even more than four, for example from five to eight, transport tracks 32 can be provided.

The transport system 28 comprises a drive device 36 having drive components which are arranged outside the process space 20 upstream, in the transport direction 30, of the entry 22 of the process space. In the present working example, the drive device 36 is configured as pusher device in which a motor-driven pusher punch 38 is coupled via a drive rod 40 with a drive motor 42, which are among such drive components. The pusher punch 38 pushes support trays 34 arranged next to one another depending on the number of transport tracks 32 through the entry 22 into the process space 20. Each of these support trays 34 pushes against a first support tray 34, viewed in the transport direction 28, of a respective transport track 32 which is already present in the process space 20, as a result of which all support trays 34 present in the process space 20 are pushed on by one position and the last support trays 34, in the transport direction 28, are pushed through the exit 24 out of the process space 20. In general, the drive device 36 operates hydraulically and the drive motor 42 is a corresponding hydraulic cylinder, with the drive rod 40 being configured as a type of piston rod.

In modifications which are not shown individually, other designs known per se for continuous furnaces, for example all types of roller furnaces, conveyor belt furnaces, chain passage furnaces, drive-through furnaces and the like, are also possible. As an alternative, the furnace 10 can also be configured as batch furnace having only one entrance. In this case, the entry lock 26 at the same time forms the exit lock and individual batches of the material 12 are conveyed into the process space 20 through this entrance in the transport direction 30, thermally treated, then removed from the process space 20 again through the entrance in a direction opposite to the transport direction 30 and in this way altogether transported through the process space 20. For this purpose, appropriate transport devices which enable the batches of the material 12 to be conveyed in both directions are present.

The material 12 can, depending on its nature, be conveyed as such by means of the transport system 28 and, for example, placed directly on the support trays 34. This is, for example, possible when the material 12 comprises structural workpieces.

In the present working example, carrier structures 44 loaded with the material 12 are provided, which in the case of the battery cathode material 14 are configured as calcination dishes 46 and in the technical terminology of the field are known as saggars. These carrier structures 44 can be placed on top of one another to give a shelf-like transport rack 48 having a number of planes, wherein in the present working example, in each case four carrier structures 44 loaded with battery cathode material 14 form a transport rack 48 and in each case one support tray 34 carries such a transport rack 48. Two, three or more than four, for example five, six or more, planes per transport rack 48 are also conceivable; the number of possible planes depends largely on the construction height of the process space 20 and the carrier structures 44. In a modification, the transport rack 48 is a separate component, for example made of metal or ceramic, which accommodates the carrier structures 44 in a number of planes.

The carrier structures 44, and consequently also the calcination dishes 46, are configured in such a way that, in the case of carrier structures 48 stacked on top of one another, flow passages 50 remain in the transport rack 48 so that a respective interior space of the carrier structures 44 or the calcination dishes 46, in which the material 12 is accommodated, remains fluidically connected to the surroundings within the process space 20. In the working example shown here, a respective flow passage 50 is present on each of four sides in the circumferential direction of the transport rack 48, so that flows in or counter to the transport direction and flows transverse thereto go into the carrier structures 44 or the calcination dishes 46. In FIG. 1, the components 44 to 50 are provided with reference numerals only on the transport rack shown at far right in FIG. 1.

The furnace 10 comprises a heating system 52 which is indicated only in FIG. 1 and by means of which a process space atmosphere 54 prevailing in the process space 20 can be heated. For example, the heating system 52 for this purpose comprises, in a manner known per se, a plurality of electric heating elements which are arranged in the process space 20 but are not shown individually. Further components which are necessary and known are also not shown in the interests of clarity.

In the thermal treatment of materials 12, an offgas which has to be taken off from the process space 20 can be formed. In the calcination of battery cathode material 14, the abovementioned water or carbon dioxide CO₂, for example, is formed as offgas. In addition, lithium-containing phases can be liberated.

In order to be able to remove offgas from the process space 20, an extraction system 56 is present, which is likewise only indicated and comprises extraction openings (which are not shown individually) in the housing 16, for example in the bottom thereof, through which the offgas can be extracted from the process space 20. Here too, necessary components which are known per se, e.g. blowers, conduits, filters and the like, are not shown individually in the interests of clarity.

Materials 12 which require a process gas for their thermal treatment can be thermally treated in the furnace 10. In the case of the abovementioned battery cathode material 14, oxygen O₂, for example, is required for effective calcination and this is blown in the form of conditioned air into the process space 20. In this case, air consequently forms such a process gas. The oxygen O₂ present therein is reacted in the formation of the metal oxide and water or carbon dioxide CO₂ is formed. In other processes, other process gases can be necessary. In some processes, air enriched with oxygen or even pure oxygen are required; the oxygen content of such process gases can be from 21% to 100%. An inert gas can also be a process gas required for trouble-free thermal treatment.

The furnace 10 therefore comprises a process gas system 58 which is again only indicated and by means of which a process gas which is required for the thermal treatment of the material 12 can be introduced into the process space 20. The process gas system 58 is designed so that the process gas reaches the material 12 through the flow passages 50 of the carrier structures 44.

To maintain the oxygen-containing atmosphere, fresh process gas is thus fed into the process space 20 by means of the process gas system 58 and the water or carbon dioxide CO₂ formed is removed from the calcination space by continuous or intermittent extraction of the process space atmosphere 54 by means of the extraction system 56.

The material 12 or carrier structures 44 loaded with material 12 are introduced through the entry lock 26 into the process space 20. The entry lock 26 is configured as a double gate lock 60 and comprises a lock space 62 having a lock inlet 64 and a lock outlet 66. Functionally, the lock outlet 66 coincides spatially with the entry 22 of the process space 20. When it is stated in the following that the lock outlet 66 is closed or opened, the entry 22 of the process space 20 is at the same time also closed or opened. In the working example shown here, the lock space 62 extends in the transport direction 30 between the lock inlet 64 and the lock outlet 66, which are opposite one another in the transport direction 30.

The lock inlet 64 and the lock outlet 66 are arranged in such a way that the material 12 or carrier structures 44 loaded with material 12 can pass through each of them in the same direction. In the present working example, the material 12 or the carrier structures 44 loaded with material 12 pass both through the lock inlet 64 and through the lock outlet 66 in the transport direction 30.

As can be seen in FIG. 1, the pusher punch 38 of the drive device 36 is arranged in the lock space 62. From there, the drive rod 40 of the drive device 36 extends through a wall denoted by 68 of the entry lock 26 out of the lock space 62 outwardly to the drive motor 42 which is arranged in the exterior surroundings of the furnace 10. In general terms, the drive device 36 comprises not only drive components outside the process space 20 but also drive components which are arranged outside the furnace 10; such drive components in the present working example include sections of the drive rod 40 located outside, which are variable because of the movement thereof, and also the drive motor 42.

A lock inlet gate device 70 having a lock inlet gate 72 by means of which the lock inlet 64 can alternatively be closed in a gastight manner or opened is present on the lock inlet 64. In this way, the lock space 62 can be isolated in a gastight manner from the exterior surroundings of the furnace 10 or be connected thereto.

In a corresponding way, a lock outlet gate device 74 having a lock outlet gate 76 by means of which the lock outlet 66 can alternatively be closed in a gastight manner or opened is present on the lock outlet 66. The lock space 62 can in this way be isolated in a gastight manner from the process space 20 or be connected thereto.

Roller gates, lifting gates or sliding gates can be used both as lock inlet gate 72 and as lock outlet gate 76. The gates can also be made up of a number of parts. One-piece roller gates are shown here by way of example.

The entry lock 26 is configured so that a replacement of atmosphere can be carried out in the lock space 62.

The entry lock 26 comprises a circulation system 78 which firstly connects the lock space 62 via an atmosphere conduit 80 to the process space 20 and secondly connects the lock space 62 via an air conduit 82 to the exterior surroundings of the furnace 10. A valve 84 and a blower 86 are arranged in the atmosphere conduit 80 so as to convey atmosphere either in the direction of the lock space 62 or in the direction of the process space 20. The air conduit 82 comprises a valve 88 and a blower 90 which can convey air either in the direction of the lock space 62 or in the direction of the exterior surroundings of the furnace 10. A control 92 controls the valves 84, 88 and the blowers 86, 90.

Due to the processes occurring in the process space 20, the process space atmosphere 54 may be polluted with materials which make handling of the process space atmosphere 54 difficult. In this case, preference is given to no process space atmosphere 54 being taken off from the process space 20 in order to flood the lock space 62. Instead, the lock space 62 can therefore be flooded, in one modification, also with a fresh auxiliary atmosphere corresponding to the unpolluted process gas atmosphere, with this not being taken from the process space 20 but instead originating from a separate source 94, which in FIG. 1 is connected by a conduit shown as a broken line to the valve 84 of the atmosphere conduit 80, which in this case is configured as three-way valve.

Upstream, viewed in the transport direction 30, of the lock inlet 64 there is an accommodation region 96 in which the material 12 or the carrier structures 44 loaded with material 12 are positioned next to one another according to the transport tracks 32 in the direction transverse to the transport direction 30 before they are conveyed into the furnace 10. For this purpose, the furnace 10 comprises an appropriate feed system 98, which is shown only in FIG. 2, having a feed conveyor 100. In the case of the carrier structures 44 used here, a stacking region 102 in which the calcination dishes 42 are stacked on top of one another and placed on a support tray 34 is provided between the feed conveyor 100 and the accommodation region 96. The feed conveyor 100 runs parallel to the transport tracks 32 outside the furnace 10. For example, the feed conveyor 100 can be configured as a roller track conveyor. The stacking region 102 is present at the side, in a direction transverse to the transport direction 30, next to the accommodation region 96, so that the carrier structures 44 are conveyed in a direction transverse to the transport direction 30 from the stacking region 102 into the accommodation region 96 and positioned there. For this purpose, the accommodation region 96 can, for example, be equipped with rollers 104 which run parallel to the transport direction 30, as can be seen in FIG. 1.

The entry lock 26 comprises an inlet conveyor 106 which is configured for conveying the material 12 or carrier structures 44 loaded with material 12 in the transport direction 30 through the lock inlet 66 into the lock space 64. For this purpose, the inlet conveyor 106 comprises, in the present working example, an inlet drive device 108 as transport means. In the present working example, the inlet drive device 108, e.g. the drive device 36 of the transport system 28, is configured as pusher device and comprises an inlet pusher punch 110 which pushes support trays 34 arranged next to one another according to the number of transport tracks 32 through the lock inlet 66 into the lock space 64. The inlet pusher punch 110 is coupled by a push rod 112 to a drive motor 114. In modifications not shown individually, the inlet conveyor 106 can also have alternative transport designs and be configured, for example, as roller track conveyor or the like.

The process space 20 defines a transport level 116 on which the material 12 or the carrier structures 44 loaded with material 12 are conveyed through the process space 20. The transport level 116 here is determined by the transport tracks 32 in the process space 20. The entry lock 26 defines an inlet level 118 on which the material 12 or the carrier structures 44 loaded with material 12 are conveyed through the lock inlet 64 into the lock space 62. The transport level 116 and the inlet level 118 are shown and provided with reference numerals only in FIG. 1.

The transport level 116 and the inlet level 118 are different from one another and thus located at different heights. Thus, the lock inlet 64 and the lock outlet 66 are opposite one another in the transport direction 30 but are, based on their passage cross section for the material 12 or the carrier structures 44 loaded with material 12, located at different height levels. The material or the carrier structures 44 loaded with material 12 pass through the lock inlet 64 and the lock outlet 66 on the different height levels of the inlet level 118 and the transport level 116.

In the present working example, the transport level 116 is lower than the inlet level 118. However, the transport level 116 can also be higher than the inlet level 118 in a modification which is not shown individually.

The material 12 or the carrier structures 44 loaded with material 12 are thus conveyed by means of the inlet conveyor 106 on the inlet level 118 into the lock space 62. In the lock space 62, the material 12 or the carrier structures 44 loaded with material 12 is moved from the inlet level 118 to the transport level 116 and then conveyed by means of the transport system 28 through the process space 20.

In order to move the material 12 or the carrier structures 44 loaded with the material 12 from the inlet level 118 to the transport level 116, the entry lock 26 comprises a lift device 120 having a transport structure 122 which can be moved between the inlet level 118 and the transport level 116. For this purpose, the transport structure 122 is coupled to a lift drive 124. In the present working example, the transport structure 122 is configured as carrier table 126 which is connected to a lift rod 128 which can be moved by a drive unit.

The lift drive 124 can also comprise drive elements in the form of ropes, chains, pressure cylinders, shearing elements, eccentric devices or the like.

The carrier table 126 can additionally be equipped with accommodation elements for the material 12 or for carrier structures 44 loaded with material 12, for example in the form of slide strips, roller bodies or the like. Stops or other alignment aids and guides, which can also be movable, can also be provided.

The lift rod 128 extends downward through the bottom of the entry lock 26 to the exterior drive unit 130. The lift rod 128 can be in one piece but can also be telescopic and, for example, work together with a then hydraulic drive unit 130. It is also possible to provide a plurality of parallel lift rods 128 which bear the carrier table 126.

In the present working example, the movement of the material 12 or the carrier structures 44 loaded with the material 12 is effected by means of the lift device 120 in the vertical direction perpendicular to the transport direction 30. In a modification which is not shown individually, the movement can additionally comprise a movement component in or opposite to the transport direction 30.

FIGS. 3A to 3F illustrate the introduction of carrier structures 44 loaded with material 12 into the process space 20 of the furnace 10, with only the components and constituents mentioned below being provided with reference numerals, insofar as they are shown in FIGS. 3A to 3F. There, not all components and constituents shown in FIG. 1 are depicted in the interests of clarity. For individual processes or operations, the approximate time in seconds [sec.] required by an individual process or operation is indicated below. These periods of time are merely illustrative and are intended to provide illustrative information about the time relationship between the individual processes and operations. However, the periods of time required in each case can in practice deviate therefrom and depend on the specific structural features, in particular the transport techniques and the circulation system 78 and the volumes moved thereby.

In the starting situation as shown in FIG. 3A, the lock inlet gate 72 on the lock inlet 64 is open and the lock outlet gate 76 on the lock outlet 66 or at the entry 22 into the process space 20 is closed; ambient atmosphere prevails in the lock space 62. The transport structure 122 of the lift device 120 of the entry lock is on the inlet level 118 and carrier structures 44A are positioned in the acceptance region 96 as an extension of the respective transport tracks 32, in each case on a support tray 34 as is described above and can be seen in FIG. 2.

The inlet conveyor 106 is then activated and the carrier structures 44A are moved within about 5 sec. from the acceptance region 96 through the lock inlet 64 into the lock space 62 and there moved onto the transport structure 122, as shown in FIG. 3B. In the working example specifically shown, the inlet pusher punch 110 is moved back to its initial position within about 2 seconds.

The lock inlet gate 72 is closed within about 3 seconds, as shown in FIG. 3C. The circulation system 78 is controlled so that the ambient atmosphere is displaced from the lock space 62 and replaced by process space atmosphere 54 or by the auxiliary atmosphere from the source 94. This operation takes about 120 seconds at the sizes shown here. In the case of lock spaces having different dimensions, the duration of this operation changes accordingly.

Preferably at the same time or optionally even afterward, the lift device 120 is actuated so that the material 12 or the carrier structures 44A loaded with material 12 are moved from the inlet level 118 to the transport level 116; see FIG. 3D. In the present case, the transport structure 122 is for this purpose lowered within about 10 seconds.

FIG. 3E illustrates that the transport structure 122 has now arrived at the transport level 116, that the lock outlet gate 76 has been opened within about 3 seconds and that the material 12 or the carrier structures 44A loaded with material 12 are transported by means of the transport system 28 from the lock space 62 through the entry 22 into the process space 20. Here, the carrier structures 44 which are already present in the process space 20 are pushed in each case one position further on, as is described above.

For this purpose, an initial movement lasting about 2 seconds of the pusher punch 38 of the drive device 36 to the support trays 34 with the carrier structures 44A firstly occurs, followed by a quick advance taking about 19 seconds until the carrier structures 44A reach the carrier structures 44 present in the process space 20, after which a slow advance movement taking 70 seconds occurs.

At the same time and optionally even from the moment at which the acceptance region 96 is accessible, carrier structures 44B are positioned in front of the lock inlet 64.

After the carrier structures 44A have been completely conveyed into the process space 20, the pusher punch 38 is pulled back within about 17 seconds, the lock outlet gate 76 is closed within about 3 seconds and the circulation system 78 is controlled in such a way that the atmosphere is conveyed out of the lock space 62 into the process space 20. As an alternative, this replacement can be carried out by opening the lock inlet gate 72 within about 10 seconds if the atmosphere in the lock space 62 permits. The transport structure 122 of the lift device 120 is moved back from the transport level 116 to the inlet level 118 and in the present case raised in about 10 seconds for this purpose. This is shown in FIG. 3F. This can occur at the same time or after the change of atmosphere in the lock space 62.

When the transport structure 122 is back on the inlet level 118, the situation shown in FIG. 3A has been restored and a further locking operation can be carried out.

Overall, about 256 seconds are required for such a locking operation.

FIGS. 4 and 5 show, as second working example, an apparatus 10′ which will hereinafter be referred to as furnace 10′. Components which correspond functionally to one another bear the same reference numerals as in the case of the working example of the furnace 10 in FIGS. 1 to 3. The exit 24 from the process space 20 is not shown.

In contrast to the furnace 10, the lock inlet 64 and the lock outlet 66 or the entry 22, which is spatially coincident therewith, of the process space 20 are not opposite one another in the transport direction 30 in the case of the furnace 10′. The lock inlet 64 and the lock outlet 66 are arranged in such a way that the material 12 or carrier structures 44 loaded with material 12 can pass through them in different directions.

The lock space 62 is arranged above the lock outlet 66, or in other words the lock outlet 66 is provided at the bottom of the lock space 62. The lock outlet gate 76 runs in a horizontal plane in its closed position. Thus, material 12 or carrier structures 44 loaded with material 12 pass through the lock inlet 64 only in the transport direction 30 during introduction of material 12 or carrier structures 44 loaded with material 12; the material 12 or carrier structures 44 loaded with material 12 pass through the lock outlet 66 in a direction different from the transport direction 30. In the present working example, this is the vertical direction.

Here too, the transport level 116 is thus lower down than the inlet level 118.

In a modification which is not shown individually, the lock space 62 can also be arranged below the lock outlet 66, which leads to the transport level 116 being higher than the inlet level 118. In further modifications which are not shown individually, the lock space 62 can also be arranged, as an alternative or in addition, below or above the lock inlet 64. In these cases, the level of the lock inlet 64 as reference is employed as inlet level 118.

In the furnace 10′, the driving rod 40 does not extend through a wall of the entry lock 26 but instead extends through an end wall denoted by 132 of the process space 20 out of the process space 20 outwardly to the drive motor 42 which is arranged in the exterior surroundings of the furnace 10′.

The transport structure 122 of the lift device 120 comprises one or more grasping units 134 for the material 12 or for carrier structures 44 loaded with material 12. In the present working example, a separate grasping unit 134 is present for each support tray 34 which accommodates material 12 or carrier structures 44 loaded with material 12; this grasping unit 134 can alternatively hold or release the accommodation tray 34 together with material 12 or together with carrier structures 44 which are loaded with material 12.

For this purpose, or for the material 12 or carrier structures 44 loaded with material 12 without support tray 34, the grasping unit 134 can comprise, for example, holding elements 136 which can be moved between a hold position and a release position. In the hold position, the holding elements 136 are arranged and oriented so that the material 12 or the carrier structures 12 loaded with material or a support tray 34 can be carried. In the release position, the holding elements 136 are oriented so that the grasping unit 134 can be moved past the material 12 or the carrier structures 44 loaded with material 12.

One or more such grasping units 134 can be connected as a type of hanging grasper to the lift rod 128 which in this case extends upward through the top of the entry lock 26 to the drive unit 130. The lift rod 128 can here also have a telescopic structure and work together with, for example, a hydraulic drive unit 130. It is also possible for a plurality of lift rods 128 to be present.

FIGS. 5A to 5F show the introduction of carrier structures 44 loaded with material 12 into the process space 20 of the furnace 10′; once again, only the components and constituents mentioned below are provided with reference numerals, insofar as they are shown in FIGS. 5A to 5F. There, not all components and constituents shown in FIG. 4 are depicted in the interests of clarity. The periods of time required for the individual processes and operations can be of the same order of magnitude to the periods of time indicated for FIGS. 3A to 3F. The replacement of atmosphere in the lock space 62 can, however, be carried out within about 80 seconds and thus more quickly, since the lock space 62 of the furnace 10′ is smaller than the lock space 62 of the furnace 10.

In the starting situation as per FIG. 5A, the lock inlet gate 72 at the lock inlet 64 is open and the lock outlet gate 76 at the lock outlet 66 or at the entry 22 into the process space 50 is closed; ambient atmosphere prevails in the lock space 62. The transport structure 122 of the lift device 120 of the entry lock 26 is at the inlet level 118; the holding elements 136 are in the hold position. In the acceptance region 96, carrier structures 44A are positioned as an extension of the respective transport tracks 32 on a respective support tray 34, as has been described above and can be seen in FIG. 2 for the example of the furnace 10.

The inlet conveyor 106 is then activated and the carrier structures 44A are moved within about 5 seconds from the acceptance region 96 through the lock inlet 64 into the lock space 62 and there onto the transport structure 122, as is shown in FIG. 5B. In the working example specifically shown, the inlet pusher punch 110 is moved back into its initial position within about 2 seconds.

The lock inlet gate 72 is closed within about 3 seconds, as shown in FIG. 5C. The circulation system 78 is controlled so that the ambient atmosphere is displaced from the lock space 62 and replaced by process space atmosphere 54 or by the auxiliary atmosphere from the source 94; this takes about the 80 seconds mentioned. In the case of lock spaces having different dimensions, the duration of this operation changes correspondingly.

As shown in FIG. 5D, the lock outlet gate 76 is then opened within about 3 seconds and the lift device 120 is subsequently actuated, so that the material 12 or the carrier structures 44A loaded with material 12 are moved from the inlet level 118 to the transport level 116. In the present case, the transport structure 122 is lowered vertically within about 10 seconds and the material 12 or the carrier structures 44 loaded with material 12 go through the lock outlet 66 and the entry 22 of the process space 20.

In contrast to the furnace 10 as shown in FIGS. 1 to 3, the material 12 or the carrier structures 44 loaded with material 12 are thus not moved through the entry 22 of the process space 20 by means of the transport system 28 in the case the furnace 10′, but instead are moved by the lift device 120 of the entry lock 26.

FIG. 5E illustrates that the holding elements 136 are then moved into their release position, which takes about 2 seconds, and the transport structure 122 with the material 12 or the carrier structures 44 loaded with material 12 are moved upward back into the lock space 62; this takes about 10 seconds.

The lock outlet gate 76 is then closed within about 3 seconds.

The material 12 or the carrier structures 44A loaded with material is then moved by means of the transport system 28 in the transport direction 30 into the process space 20, with there once again being a 2 second start time, a 19 second rapid advance and a 70 second slow advance of the pusher punch 38. Here, the carrier structures 44 already present in the process space 20 are each pushed further on by one position, as is described above; this is shown in FIG. 5F. The pusher punch 38 is then moved back again within about 17 seconds.

At the same time, namely after the lock outlet gate 76 has been closed, the circulation system 78 is controlled in such a way that the atmosphere is conveyed out of the lock space 62 into the process space 20.

Likewise at the same time and optionally even from the moment at which the acceptance region 96 is accessible, carrier structures 44B are positioned there in front of the lock inlet 64.

Ambient atmosphere is then admitted into the lock space 62 and the lock inlet gate 72 is opened; the situation shown in FIG. 5A has been restored again and a further locking operation can be carried out.

Since the processes and operations in the lock space 62 and in the process space 20 which occur after closing of the lock outlet gate 76 are carried out in parallel, a locking operation can be carried out altogether more quickly and in about half the time in the case of the furnace 10′ compared to the furnace 10.

FIG. 6 illustrates a furnace which is known from the market and in which functionally corresponding components and constituents bear, in the interests of clarity, the same reference numerals used in FIGS. 1 to 5. The lock space 62 is charged in a direction perpendicular to the transport direction 30. As can be seen from FIG. 6, the acceptance region 96 has to be provided for this purpose at the side next to the entry lock 26 with an extension perpendicular to the transport direction 30, which corresponds to the extension of the transport tracks 32 in the direction perpendicular to the transport direction 30.

In the case of furnaces 10 and 10′, by contrast, space which is required in the direction perpendicular to the transport direction 30 for the furnace according to the prior art as per FIG. 6 is saved. This is achieved according to the invention by both the entry lock 26 and the process space 20 being able to be charged in the transport direction 30. This is in turn made possible by the inlet level 118 and the transport level 116 being different, as a result of which the drive components of the entry lock 26 and of the process space 20, which are arranged outside the furnace 10, can likewise be arranged at different height levels and do not interfere with one another.

The process space 20 can in principle operate as superatmospheric pressure system, so that there is no risk of atmosphere from the outside getting into the process space 20 and being able to interfere in the processes occurring in the process space 20.

In a preferred variant, especially in connection with the calcination of battery cathode material, the entry lock 26 is constructed without metal since even traces of metal in the atmosphere significantly interfere with the calcination process in particular. Components and constituents can for this reason be made of nonmetallic materials, for example ceramics or polymers. As an alternative, components and constituents of the entry lock can also be coated or lined with appropriate nonmetallic materials. Movable components such as the drive rod 40 can, for example, be surrounded by a bellows or the like.

What is claimed is:

1. An apparatus for the thermal or thermochemical treatment of material, comprising:
a) a housing;
b) a process space which is located in the housing and in which a process space atmosphere prevails during the treatment and which defines a transport level;
c) a transport system by means of which material or carrier structures loaded with the material can be transported on the transport level in a transport direction into and/or through the process space;
d) an entry lock which defines an inlet level and
da) comprises a lock space, a lock inlet and a lock outlet;
db) comprises an inlet conveyor which is configured in such a way that the material or carrier structures loaded with material can be transported on the inlet level through the lock inlet into the lock space;
wherein
e) the transport level and the inlet level are different from one another.

2. The apparatus as claimed in claim 1, wherein the transport level is lower than the inlet level.

3. The apparatus as claimed in claim 1, wherein the entry lock comprises a lift device having a transport structure by means of which the material or the carrier structures loaded with material can be moved from the inlet level to the transport level.

4. The apparatus as claimed in claim 3, wherein the transport structure has at least one carrier table or at least one grasping unit.

5. The apparatus as claimed in claim 3, wherein the inlet conveyor is configured so that the material or the carrier structures loaded with the material can be transported on the inlet level on the transport structure of the lift device.

6. The apparatus as claimed in claim 1, wherein the lock inlet and the lock outlet are arranged in such a way that the material or the carrier structures loaded with material can pass through them in the same direction.

7. The apparatus as claimed in claim 6, wherein the material or the carrier structures loaded with material can pass in the transport direction through the lock inlet and the lock outlet.

8. The apparatus as claimed in claim 1, wherein the lock inlet and the lock outlet are arranged in such a way that the material or the carrier structures loaded with material can pass through them in different directions.

9. The apparatus as claimed in claim 8, wherein
a) at least either the lock inlet or the lock outlet is arranged in such a way that the material or the carrier structures loaded with material can pass through it in the transport direction;
and/or
b) at least either the lock inlet or the lock outlet is arranged in such a way that the material or the carrier structures loaded with material can pass through it in the vertical direction.

10. The apparatus as claimed in claim 1, wherein the transport system comprises a drive device having drive components which are arranged outside the apparatus upstream, relative to the transport direction, of an entry into the process space.

11. The apparatus as claimed in claim 1, wherein the entry lock is configured in such a way that a replacement of atmosphere can be carried out in the lock space.

12. A process for the thermal or thermochemical treatment of material comprising the steps of:
a) transporting material or carrier structures loaded with material on a transport level through a process space of an apparatus for the thermal treatment of the material in which a process gas atmosphere prevails;
b) transporting the material or the carrier structures loaded with material on an inlet level into a lock space of an entry lock, wherein
c) the material or the carrier structures loaded with material are transported on the transport level and the inlet level at different heights.

13. The process as claimed in claim 12, wherein a replacement of atmosphere is carried out in the lock space when material or the carrier structures loaded with material are introduced into the process space.

14. The process as claimed in claim 13, wherein the material or the carrier structures loaded with material are moved in the lock space from the inlet level to the transport level (116) while the exchange of atmosphere is carried out.

15. The process as claimed in claim 11, wherein an apparatus as claimed in claim 1 is used.
